(19) United States
(12) Patent Application Publication
(10) Pub. No.: US 2010/0261808 A1
(43) Pub. Date: Oct. 14, 2010

(54) DIBLOCK COPOLYMER MODIFIED NANOPARTICLE/POLYMER COMPOSITES

(75) Inventors: Linda S. SCHADLER, Niskayuna, NY (US); Brian BENICEWICZ, Columbia, SC (US); Yu Li, Columbia, SC (US)

Correspondence Address: HESLIN ROTHENBERG FARLEY & MESITI PC, 5 COLUMBIA CIRCLE, ALBANY, NY, 12203, US

(73) Assignee: RENSSELAER POLYTECHNIC INSTITUTE, Troy, NY (US)

(21) Appl. No.: 12/757,671

(22) Filed: Apr. 9, 2010

Related U.S. Application Data
(60) Provisional application No. 61/212,386, filed on Apr. 10, 2009.

(51) Int. Cl. C08K 9/04; B32B 5/00

(52) U.S. Cl. 523/205; 428/407; 977/773

(57) ABSTRACT

The invention relates to a modified nanoparticle including a nanoparticle and a diblock copolymer covalently attached to the nanoparticle, the diblock copolymer comprising a first block polymer of molecular weight greater than 1000 attached to the nanoparticle and a second block polymer of molecular weight greater than 1000 covalently linked to the first block polymer, wherein at least one of the first block polymer and second block polymer comprises repeating units having an azide, acetylene or triazole side chain. Nanocomposites incorporating modified nanoparticles, as well as methods of making modified nanoparticles and nanocomposites are also disclosed.

### CROSS-REFERENCE TO RELATED APPLICATIONS

This application claims priority under 35 U.S.C. §119 to U.S. Provisional Application No. 61/212,409, filed Apr. 10, 2009, which is herein incorporated by reference in its entirety.

### GOVERNMENT RIGHTS STATEMENT

The U.S. Government has a paid-up license in this invention and the right in limited circumstances to require the patent owner to license others on reasonable terms as provided for by the terms of Grant No. DMR-0642573 awarded by the National Science Foundation (NSF).

### BACKGROUND OF THE INVENTION

1. Technical Field

The invention relates generally to nanoparticles, and more particularly to nanoparticle-filled polymer nanocomposites.

2. Background Information

Nanoparticles are gaining considerable interest for a wide variety of applications in the electronic, chemical, optical and mechanical industries due to their unique physical and chemical properties. Nanoparticles can be made of a variety of materials and are typically defined as particles having a diameter of 1-100 nanometers. Recently, the modification of nanoparticles in order to change their physical and chemical properties has become an area of significant research.

One way to modify nanoparticles is through reversible addition-fragmentation chain transfer (RAFT) polymerization. RAFT polymerization is a recently developed controlled rapid polymerization (CRP) technique that is used to prepare polymer materials with predetermined molecular weights, narrow polydispersities, and advanced architectures. RAFT has been used to surface modify nanoparticles with a bound polymer in order to minimize steric crowding between nanoparticles and impart superior dispersion characteristics to modified particles.

Nanoparticles have been used to modify the properties of certain industrial polymers, such as epoxides. Epoxides are used in a wide variety of applications. Epoxy is a thermosetting epoxide polymer that cures (polymerizes and crosslinks) when mixed with a curing agent or “hardener” and a catalyst. Some practitioners have used fillers, including nanoscale fillers, to try to improve the characteristics of epoxides. These composites tend to have trade offs versus a neat epoxy (an epoxy with no filler), for example, the use of a particular filler may increase the stiffness of the epoxy while concurrently decreasing its ductility and opacity.

Click chemistry is a chemical technique whereby chemical compounds (often polymers) are generated by joining small repeated units together, usually by a dipolar cycloaddition. Click chemistry has been used for surface modification of nanoparticles with high density polymer brushes.

### SUMMARY OF THE INVENTION

In one aspect, the invention relates to a modified nanoparticle having a diblock copolymer covalently attached to it. The diblock copolymer includes a first block polymer of molecular weight greater than 1000 attached to the nanoparticle and a second block polymer of molecular weight greater than 1000 covalently linked to the first block polymer. At least one of the first block polymer and second block polymer includes repeating units having an azide, acetylene or triazole side chain.

In another aspect, the invention relates to a nanoparticle-filled polymer composite including a modified nanoparticle and a polymeric matrix, wherein the modified nanoparticle includes a nanoparticle and a diblock copolymer covalently attached to the nanoparticle and the diblock copolymer includes a first block polymer of molecular weight greater than 1000 attached to the nanoparticle and a second block polymer of molecular weight greater than 1000 covalently linked to the first block polymer. In this embodiment, the second block polymer and polymeric matrix both possess the same chemical functionality.

In another aspect, the invention relates to a method for preparing a nanoparticle-filled polymer composite including the steps of (a) providing a modified nanoparticle, (b) immersing the nanoparticle in a prepolymer resin, and (c) polymerizing the resin, wherein the modified nanoparticle is modified such that a block copolymer is attached to the nanoparticle, the block copolymer having an inner polymer proximal to the nanoparticle and a matrix-compatible outer polymer distal to the nanoparticle.

In another aspect, the invention relates to a method for preparing a nanoparticle filled polymer composite including the steps of a) providing a nanoparticle, b) melting or dissolving a polymer matrix, c) immersing the modified nanoparticle in the polymer matrix, and d) allowing the nanoparticle filled polymer matrix to harden, wherein the nanoparticle is modified such that a diblock copolymer is attached to the nanoparticle, the diblock copolymer having a first block polymer proximal to the nanoparticle and a matrix compatible second block polymer distal to the nanoparticle.

In yet another aspect, the invention includes a method for preparing a nanoparticle-filled polymer composite including the steps of (a) covalently attaching to a nanoparticle, by RAFT polymerization, a diblock copolymer, the diblock copolymer including a first block polymer attached to the nanoparticle and a second block polymer covalently linked to the first block polymer, wherein at least one of the first block polymer and second block polymer include repeating units having a side chain that supports a dipolar cycloaddition, (b) carrying out a dipolar cycloaddition such that a product of the cycloaddition is preferentially attached to side chains of one or the other of the first block polymer and the second block polymer (c) immersing the nanoparticle in a prepolymer resin and (d) polymerizing the resin.

A still further aspect of the invention is a method for preparing a nanoparticle filled polymer composite including the steps of a) covalently attaching to a nanoparticle, by RAFT polymerization, a diblock copolymer, the diblock copolymer including a first block polymer attached to the nanoparticle and a second block polymer covalently linked to the first block polymer, wherein at least one of the first block polymer and second block polymer include repeating units having a side chain that supports a dipolar cycloaddition, b) carrying out a dipolar cycloaddition such that a product of the cycloaddition is preferentially attached to side chains of one or the other of the first block polymer and the second block polymer, c) melting or dissolving a polymer matrix, d) immersing the modified nanoparticle in the polymer matrix, and e) allowing the nanoparticle filled polymer matrix to harden.

These, and other objects, features and advantages of this invention will become apparent to those of skill in the art from the following detailed description of various aspects of the invention.

### DETAILED DESCRIPTION OF THE INVENTION

The present invention provides for modified nanoparticles, nanocomposites, and methods of making modified nanoparticles and nanocomposites. The following description is intended to provide examples of the invention and to explain how various aspects of the invention relate to each other. However, it is important to note that the scope of the invention is fully set out in the claims and this description should not be read as limiting those claims in any way.

### Nanoparticle

The present invention, in one aspect, is a modified nanoparticle comprising a nanoparticle and a diblock copolymer covalently attached to the nanoparticle, wherein the diblock copolymer includes a first block polymer of molecular weight greater than 1000 attached to the nanoparticle and a second block polymer of molecular weight greater than 1000 covalently linked to the first block polymer, wherein at least one of the first block polymer and second block polymer is composed of repeating units having an azide, acetylene or triazole side chain. For example, a depiction of such a nanoparticle would be:

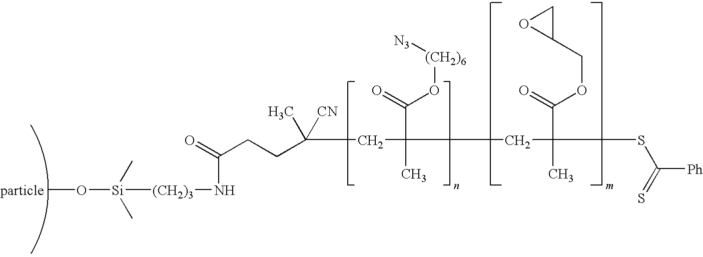

In this depiction, the first block polymer is a methacrylate having an azide on the side chain. The second block polymer is a methacrylate having a glycidic ether side chain. The azide may be reacted with an acetylene to provide an embodiment in which the first block polymer is a methacrylate having a triazole on the side chain, as shown:

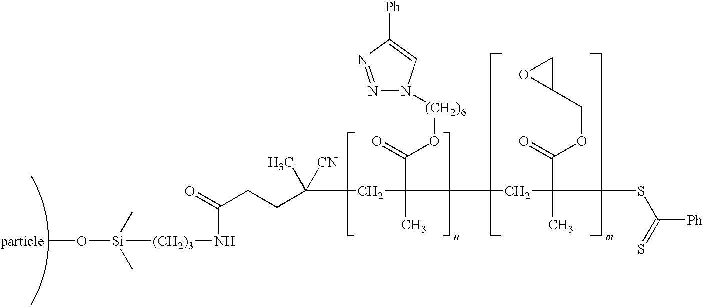

In this depiction, the azide has been reacted with phenylacetylene via a 2+2 cycloaddition, which is one embodiment of the so-called “click” chemistry. In another depiction of an exemplary embodiment, the first block polymer is a methacrylate having an azide on the side chain and the second block polymer is a polystyrene:

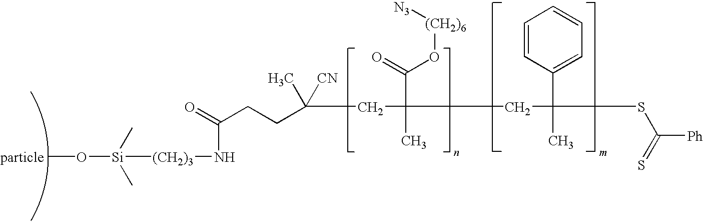

In the embodiment depicted, the value of n will be greater than 5 and the value of m will be greater than 9 to meet the requirement of molecular weight greater than 1000. In certain embodiments n will be 50 to 250 and m will be 90 to 1600. The values of n and m are, of course, dependent on the nature and size of the constituent repeating units.

In yet another depiction of an exemplary embodiment, the first constituent polymer of the diblock copolymer is n-hexyl methacrylate and the second constituent polymer of the diblock copolymer is a polymethacrylate having a triazole on the side chain, and the triazole is itself substituted so that it carries a RAFT-generated polystyrene:

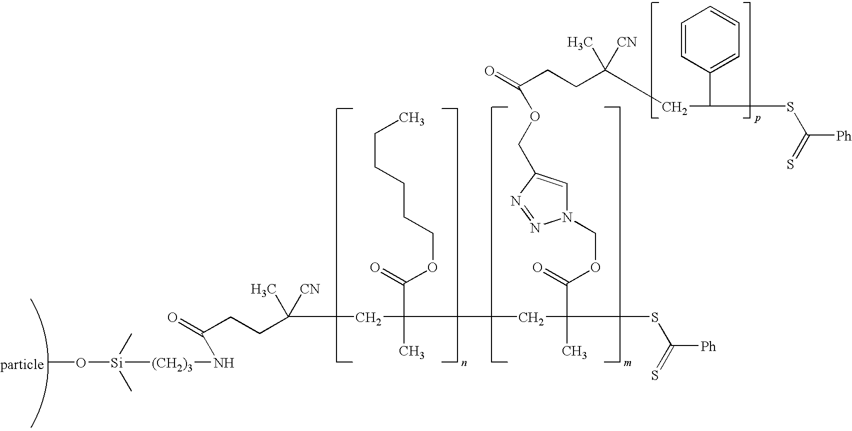

In the formula above, p is an integer from 2 to 2,000.

Suitable nanoparticles may be made from any desired material, without limitation. By way of example, nanoparticles suitable for use in the invention may be made from any of the following, including, but not limited to, inorganic particles, for example, metal oxides, such as, but not limited to, silica, aluminum oxide, titanium oxide, tin oxide. The particles may also be composed of organic particles, such as semiconductor polymer particles, rubber particles, or another organic material suitable for a particular application. For the purposes of this disclosure, the term “nanoparticle” is used in a broad sense, though for illustrative purposes only, some typical attributes of nanoparticles suitable for use in this invention are a particle size of between 1-100 nanometers and, with regards to particle shape, an aspect ratio of between 1 and 1,000.

Attachment of the diblock copolymer to the nanoparticle can be achieved in any reaction such that a covalent bond between the nanoparticle and the diblock copolymer results. One non-limiting example of an acceptable attachment reaction is reversible addition-fragmentation chain transfer (RAFT) polymerization. RAFT polymerization reactions are performed under mild conditions, typically do not require a catalyst, and are applicable to a wide range of monomers. Monomers suitable for use in the practice of the invention include, but are not limited to: acrylates, methacrylates, phenylacetylene, and styrene. Although several approaches employing RAFT techniques are within the scope of the invention, an example of one particular RAFT reaction is surface-initiated RAFT. Surface-initiated RAFT is particularly attractive due to its ability to provide precise control over the structure of the grafted polymer chains and provide significant control over the graft density of the polymer chains. RAFT can be used to attach a block polymer to the nanoparticle and a second block polymer can be attached via any suitable chemical reaction such that the first block polymer is covalently bonded to the second block polymer.

Click reactions are one suitable class of reactions that may be used to attach suitable functionality to a polymer layer. While any form of click chemistry is within the scope of the invention, an example is the use of azide-alkyne click chemistry, with a more specific example being the copper catalyzed variant of the Huisgen dipolar cycloaddition reaction. There are two major methods for producing functionalized polymers using click chemistry and both methods are included in the scope of the invention without limiting the invention to those two methods. The first major method includes use of a RAFT agent containing an azide or alkyne moiety to mediate the polymerization of various monomers. The resulting polymers contain terminal alkynyl or azido functionalities, which are then used in click reactions with functional azides or alkynes, respectively. This method can also be used to synthesize block copolymers by cojoining azide and alkyne end-functionalized polymer pairs. The second method employs a polymer with pendant alkynyl or azido groups synthesized via RAFT polymerization. These polymers are then side-functionalized via click-reactions. Block copolymers can be synthesized using this method as well.

In other aspects of the invention, block copolymers may be synthesized prior to attachment to the nanoparticle. Block copolymers suitable for use in the practice of this invention include but are not limited to: poly[(6-azidohexyl methacrylate)ₙ-b-(styrene)ₘ] and poly[(hexyl methacrylate)ₙ-b-(glycidyl methacrylate)ₘ].

In certain embodiments, wherein the first block polymer has a triazole side chain, the triazole side chain can include a polyaniline or a polyolefin. In other embodiments, wherein the second block polymer has a triazole side chain, the triazole can include a glycidyl ether, an ester, an aliphatic hydrocarbon, an aromatic hydrocarbon, a phenol, an amide, an isocyanate, or a nitrile group. Several aspects of the invention will have a first block polymer including repeating units having a triazole in the side chain and/or a second block polymer having repeating units having a triazole in the side chain.

An exemplary structure of a triazole that may be present in the first block polymer according to aspects of the invention is:

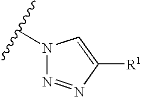

where R1 is chosen from a polyaniline, a polyolefin, and the wavy line indicates the point of attachment to the side chain.

An exemplary structure of a triazole that may be present in the second block polymer according to aspects of the invention is:

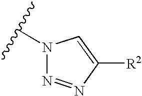

where R2 is chosen from a glycidyl ether, an ester, an aliphatic hydrocarbon, an aromatic hydrocarbon, a phenol, an amide, an isocyanate and a nitrile and the wavy line indicates the point of attachment to the side chain.

The size ranges of the individual block polymers and overall length of the diblock copolymer can vary within the scope of the invention, as desired, in an application-specific manner. As a non-limiting example, suitable lengths for the overall diblock copolymer can range from 2 Kg/mole to 200,000 Kg/mole. Additionally, each of the first block polymer and second block polymer can be of a length of 1 Kg/mole to 199,000 Kg/mole. Typically, the first block polymer will have a length between 10,000 Kg/mole and 50,000 Kg/mole and the second block polymer will have a length of up to 190,000 Kg/mole. Techniques such as RAFT allow for precise tailoring of the lengths of the block polymers.

The composition of the diblock copolymer can vary to produce a certain characteristic in a desired application such as enhanced mechanical toughness, such as increased fracture resistance of an epoxy, or increased electrical conductance of a material after addition of the modified nanoparticle. One example embodiment of the invention that achieves an enhanced mechanical toughness when added to an epoxy matrix is a silicon nanoparticle wherein the diblock copolymer is structured to include an inner block with glass transition temperature well below room temperature (a rubber) and an outer block compatible with the matrix which can have a range of glass transition temperatures, for example, a higher glass transition temperature than the first block polymer layer.

Aspects of the invention can have varying graft densities of copolymers attached to the nanoparticles. Graft densities within the scope of aspects of the invention include, but are not limited to, 0.01 to 1.0 chains/nm² as measured by ultravioletvisible-absorption spectroscopy.

### Nanocomposite

Another aspect of the invention is a nanoparticle filled polymer composite including a modified nanoparticle and a polymeric matrix, wherein the modified nanoparticle includes a nanoparticle and a diblock copolymer covalently attached to the nanoparticle, the diblock copolymer including a first block polymer of molecular weight greater than 1000 attached to the nanoparticle and a second block polymer of molecular weight greater than 1000 covalently linked to the first block polymer, wherein the second block polymer and the polymeric matrix both possess the same chemical functionality.

The term “chemical functionality” is interchangeable with “functional group” and would be readily understood by the person of skill in the art. The term is used in its normal sense, as defined in the Dictionary of Science and Technology (Academic Press 1992): “In a carbon-hydrogen molecule [a functional group is] an atom or group of atoms replacing a hydrogen atom; [it may also be] a reactive group having specific properties, such as a double bond.” In the context used herein to describe the relationship between the second block polymer and the polymeric matrix, for example, the matrix may arise from polymerization of an epoxide, and the second block polymer will then possess the epoxide functionality in its side chain. In similar fashion, the resin/matrix may be a polyester, and the second block polymer will possess the carboxylic ester functionality in its side chain; or the resin/matrix may be a polyolefin, and the second block polymer will possess hydrocarbon functionality in its side chain.

The term “compatible” as used herein means that the outer polymer is chemically similar enough to the polymer matrix that the dispersion of the nanoparticle meets at least one of the following criteria: a) the largest agglomerates of modified nanoparticles in the polymer matrix after dispersion and mixing are 500 nm in diameter and at least 50% of the agglomerates have a diameter less than 250 nanometers, b) the largest agglomerates of modified nanoparticles in the polymer matrix after dispersion and mixing are 100 nanometers in diameter and no more than 50% of the agglomerates are 100 nanometers in diameter, or c) at least 50% of the modified nanoparticles are individually dispersed in the polymer matrix after dispersion and mixing.

In particular embodiments of the invention, the second block polymer and the polymeric matrix will have identical functionalities, for example, when they are each of the same chemical class. Non-limiting examples of such chemical classes that are within the scope of the invention include, but are not limited to an epoxide/ether, an ester, an aliphatic hydrocarbon, an aromatic hydrocarbon, a phenol/resole, an amide, an isocyanate/urethane, and a nitrile.

Modified nanoparticles suitable for use in this aspect of the invention include all of the modified nanoparticles discussed above or other suitable application-specific nanoparticles. The amount of modified nanoparticle present in a given embodiment of the invention, relative to the amount of polymeric matrix present, can vary as desired in an application-specific manner. A non-limiting example of amounts of modified nanoparticle typically present in various embodiments of the invention is a range where the modified nanoparticle volume fraction is between about 0.1 percent and about 25 percent.

Any suitable polymeric matrix can be used according to the invention, as desired. Non-limiting examples include: polyesters, vinyl esters, epoxies, phenols, polyimides, polyamides, polyethylene, polypropylene, polyether ether ketone, or other thermoplastic or application-appropriate polymer.

### Methods of Synthesis

Another aspect of the invention is a method for preparing a nanoparticle filled polymer composite including the steps of: providing a modified nanoparticle, immersing the nanoparticle in a prepolymer resin, and polymerizing the resin wherein the modified nanoparticle is modified such that a block copolymer is attached to the nanoparticle, the block copolymer having an inner polymer proximal to the nanoparticle and a matrix compatible outer polymer distal to the nanoparticle.

Yet another aspect of the invention includes a method for preparing a nanoparticle filled polymer composite including the steps of (a) covalently attaching to a nanoparticle, by RAFT polymerization, a diblock copolymer, the diblock copolymer including a first block polymer attached to the nanoparticle and a second block polymer covalently linked to the first block polymer, wherein at least one of the first block polymer and second block polymer includes repeating units having a side chain that supports a dipolar cycloaddition, (b) carrying out a dipolar cycloaddition such that a product of the cycloaddition is preferentially attached to side chains of one or the other of the first block polymer or second block polymer, (c) immersing the nanoparticle in a prepolymer resin and (d) polymerizing the resin. Examples of side chains that support dicycloaddition include, but are not limited to, azide or acetylene side chains.

A still further aspect of the invention is a method for preparing a nanoparticle filled polymer composite including the steps of a) providing a modified nanoparticle, b) melting or dissolving a polymer matrix, c) immersing the modified nanoparticle in the polymer matrix, d) allowing the nanoparticle filled polymer matrix to harden wherein the modified nanoparticle is modified such that a block copolymer is attached to the nanoparticle, the block copolymer having an inner polymer proximal to the nanoparticle and a matrix compatible outer polymer distal to the nanoparticle.

In another aspect, the invention relates to a method for preparing a nanoparticle filled polymer composite including the steps of a) providing a nanoparticle, b) melting or dissolving a polymer matrix, c) immersing the modified nanoparticle in the polymer matrix, and d) allowing the nanoparticle filled polymer matrix to harden, wherein the nanoparticle is modified such that a diblock copolymer is attached to the nanoparticle, the diblock copolymer having a first block polymer proximal to the nanoparticle and a matrix compatible second block polymer distal to the nanoparticle.

A still further aspect of the invention is a method for preparing a nanoparticle filled polymer composite including the steps of a) covalently attaching to a nanoparticle, by RAFT polymerization, a diblock copolymer, the diblock copolymer including a first block polymer attached to the nanoparticle and a second block polymer covalently linked to the first block polymer, wherein at least one of the first block polymer and the second block polymer includes repeating units having a side chain that supports dipolar cycloaddition, b) carrying out a dipolar cycloaddition such that a product of the cycloaddition is preferentially attached to side chains of one or the other of the first block polymer and the second block polymer, c) melting or dissolving a polymer matrix, d) immersing the modified nanoparticle in the polymer matrix, and allowing the nanoparticle filled polymer matrix to harden.

Appropriate nanoparticles suitable for practice in the described methods include all of the nanoparticles described in this disclosure as well as any other application-appropriate nanoparticle. Appropriate polymeric matrices also include those described in this disclosure or other application-appropriate polymeric matrices.

The nanoparticles used according to the methods of the present invention may contain diblock copolymers having differential properties between the first block polymer and the second block polymer. One non-limiting example of a functionalized nanoparticle within the scope of the invention is where the first block polymer provides a layer that possesses a mechanical, electrical or optical property different from the prepolymer resin and the second block polymer provides a layer that possesses a mechanical or chemical property compatible with the prepolymer resin. The properties of the block polymer can derive from the nature of the monomer used to form the block polymer or from the addition of side chains to the block polymer via a click reaction. Specific examples of enhanced properties of the first block polymer layer within the scope of the invention include, but are not limited to increased resiliency, electrical conductivity, electrical insulation, optical absorption, optical reflection and optical radiation.

Other embodiments of the invention may include a nanoparticle covalently bonded to a diblock copolymer, having an inner block polymer and an outer block polymer, wherein the two block polymers are selected in an application-specific manner. Specifically, aspects of the invention can include a modified nanoparticle wherein the inner block polymer is selected to provide enhanced properties to the nanoparticle or to a composite in which the nanoparticle is a constituent. Such enhanced properties can include enhanced mechanical toughness, enhanced resilience, enhanced electrical conductivity or electrical insulation properties, or enhanced optical activity such as optical absorption, optical reflection, or optical radiation. Other aspects of the invention may include an outer block polymer having similar chemical functionality to a polymeric matrix to which it is added.

### EXAMPLES

Explained herein are embodiments of the invention describing optimization of mechanical properties of nanoparticle-filled nanocomposites. The invention may, however, be embodied in many different forms and should not be construed as being limited to the exemplary embodiments set forth herein; rather, these embodiments are provided so that this disclosure will be thorough and complete, and will fully convey the concept of the invention to those skilled in the art.

### Example 1

In this example, reversible addition-fragmentation chain transfer (RAFT) polymerization combined with click chemistry was used to graft polymers on SiO₂ nanoparticles (ORGANOSILICASOL™ colloidal silica in Methyl isobutyl ketone (MIBK) from Nissan Chemical). 4-Cyanopentanoic acid dithiobenzoate (CPDB) served as the RAFT reaction agent.

The nanoparticles were modified using a living free radical polymerization method and a click chemistry functionalization method to create a electrically conducting inner block (molecular weight 9.8 Kg/mole) and an outer block with polystyrene compatible groups (molecular weight 25 Kg/mole), and a graft density of 0.05 chains/nm². An example chemistry is shown in the schematic below:

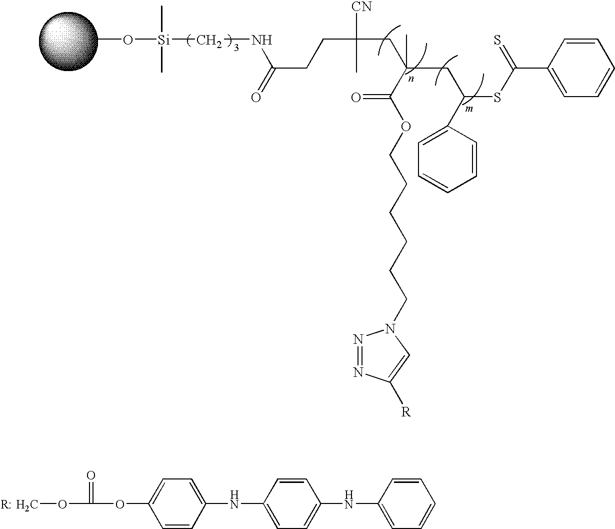

### Synthesis of 6-Azidohexyl Methacrylate (AHMA)

A solution of 1-azido-6-hydroxyhexane (14.3 g, 100 mmol), methacrylic acid (7.74 g, 90 mmol), and 4-dimethylaminopyridine (DMAP) (3.67 g, 30 mmol) in 100 mL of methylene chloride was cooled to 0° C. in a 500 mL round bottom flask. Dicyclohexylcarbodiimide (DCC) (20.63 g, 100 mmol) was dissolved in 50 mL methylene chloride and added slowly to the solution. The resulting mixture was warmed to room temperature and stirred overnight. The precipitate was removed by filtration. After removal of solvent and silica gel column chromatography (10:1 mixture of hexane and ethyl acetate), the product was obtained as a colorless liquid (yield: 16.1 g, 85%).

Graft Polymerization of AHMA from CPDB Anchored Silica Nanoparticles

A solution of AHMA (1g), 4-cyanopentanoic acid dithiobenzoate (CPDB) anchored silica (0.12 g), V-70 (0.45 μmol), and tetrahydrofuran (THF) (8 mL) was prepared in a dried Schlenk tube. The mixture was degassed by three freeze-pump-thaw cycles, back filled with nitrogen, and then placed in an oil bath at 30° C. for 6-8 hours. The polymerization was then quenched in ice water. The polymer solution was precipitated into methanol, filtered, and dried under vacuum. The cleaved PAHMA had a number-average molecular weight of 9,800 and a polydispersity index (PDI) of 1.25.

### Synthesis of SiO₂-Graft-(PAHMA-Block-PS)

A solution of SiO₂-graft-PAHMA (M_{n(cleaved PAHMA)}=9800, PDI=1.25), styrene (1.5 mL), V-70 (0.225 μmol) and THF (5 mL) was prepared in a dried Schlenk tube. The mixture was degassed by three freeze-pump-thaw cycles, back filled with nitrogen, and then placed in a 30° C. oil bath. After 11 hours, the polymerization solution was quenched in ice water and poured into an aluminum boat. Molecular weight characteristics were analyzed by gel permeation chromatograph (GPC) after cleavage from the silica. Molecular weight obtained was 16,000 g/mol.

### Synthesis of Alkyne-Terminated Oligoaniline (ALOAN)

To a 100 mL round bottom flask, a solution of 4-(4-(phenylamino) phenyl amino)phenol (2.76 g, 10 mmol) and triethylamine (10.1 g, 11 mmol) in 50 mL of methylene chloride was cooled to 0° C. Propargyl chloroformate (1.3 g, 11 mmol) was added slowly to the solution. The resulting mixture was warmed to room temperature and stirred overnight. The precipitate was removed by filtration. After removal of solvent and silica gel column chromatography (3:1 mixture of hexane and ethyl acetate), the product was obtained as a gray solid (yield: 3 g, 85%). mp: 84° C. (capillary uncorrected).

### Click Functionalization of Block-Polymer Grafted Silica Nanoparticles

A mixture of block copolymer grafted silica nanoparticles (1 equiv of —N₃), alkyne-terminated oligoaniline (2 equiv), and N,N,N′,N″,N″-pentamethyldiethylenetriamine (PMDETA) (0.5 equiv) was dissolved in THF. The solution was degassed by bubbling nitrogen for 5 minutes and transferred to a flask containing CuBr (0.5 equiv) under a nitrogen atmosphere. After reaction, the mixture was diluted with THF, and passed through neutral alumina to remove the copper catalyst. After concentration by rotary evaporation, the solution was precipitated into methanol to remove residual alkyne. After filtration, the product was dried under vacuum.

### Example 2

In this example, reversible addition-fragmentation chain transfer (RAFT) polymerization combined with click chemistry was used to graft polymers on SiO₂ nanoparticles (ORGANOSILICASOL™ colloidal silica in Methyl isobutyl ketone (MIBK) from Nissan Chemical). 4-Cyanopentanoic acid dithiobenzoate (CPDB) served as the RAFT reaction agent.

The nanoparticles were modified using a living free radical polymerization method and a click chemistry functionalization method to create a electrically conducting inner block (molecular weight 9.8 Kg/mole) and an outer block with polydimethyl siloxane compatible groups (molecular weight 150 Kg/mole), and a graft density of 0.21 chains/nm². An example chemistry is shown in the schematic below:

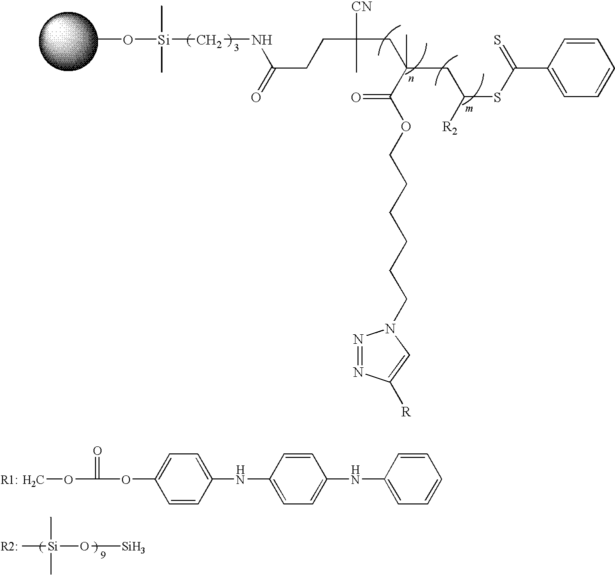

### Synthesis of 6-Azidohexyl Methacrylate (AHMA)

A solution of 1-azido-6-hydroxyhexane (14.3 g, 100 mmol), methacrylic acid (7.74 g, 90 mmol), and 4-dimethylaminopyridine (DMAP) (3.67 g, 30 mmol) in 100 mL of methylene chloride was cooled to 0° C. in a 500 mL round bottom flask. Dicyclohexylcarbodiimide (DCC) (20.63 g, 100 mmol) was dissolved in 50 mL methylene chloride and added slowly to the solution. The resulting mixture was warmed to room temperature and stirred overnight. The precipitate was removed by filtration. After removal of solvent and silica gel column chromatography (10:1 mixture of hexane and ethyl acetate), the product was obtained as a colorless liquid (yield: 16.1 g, 85%).

Graft Polymerization of AHMA from CPDB Anchored Silica Nanoparticles

A solution of AHMA (1 g), 4-cyanopentanoic acid dithiobenzoate (CPDB) anchored silica (0.12 g), V-70 (0.45 μmol), and tetrahydrofuran (THF) (8 mL) was prepared in a dried Schlenk tube. The mixture was degassed by three freeze-pump-thaw cycles, back filled with nitrogen, and then placed in an oil bath at 30° C. for 6-8 hours. The polymerization was then quenched in ice water. The polymer solution was precipitated into methanol, filtered, and dried under vacuum. The cleaved PAHMA had a number-average molecular weight of 9,800 and a polydispersity index (PDI) of 1.25.

### Synthesis of SiO₂-Graft-(PAHMA-Block-PDMS)

A solution of SiO₂-graft-PAHMA (M_{n(cleaved PAHMA)}=10000 g/mol), monomethacryloxypropyl terminated polydimethyl siloxane (PDMS-macromonomer) (5 mL), V-70 (0.225 μmol) and THF (10 mL) was prepared in a dried Schlenk tube. The mixture was degassed by three freeze-pump-thaw cycles, back filled with nitrogen, and then placed in a 30° C. oil bath. After 6 hours, the polymerization solution was precipitated in methanol and molecular weight characteristics were analyzed by GPC after cleavage from the silica. Molecular weight obtained was 150,000 g/mol.

### Synthesis of Alkyne-Terminated Oligoaniline (ALOAN)

To a 100 mL round bottom flask, a solution of 4-(4-(phenylamino) phenyl amino)phenol (2.76 g, 10 mmol) and triethylamine (10.1 g, 11 mmol) in 50 mL of methylene chloride was cooled to 0° C. Propargyl chloroformate (1.3 g, 11 mmol) was added slowly to the solution. The resulting mixture was warmed to room temperature and stirred overnight. The precipitate was removed by filtration. After removal of solvent and silica gel column chromatography (3:1 mixture of hexane and ethyl acetate), the product was obtained as a gray solid (yield: 3 g, 85%). mp: 84° C. (capillary uncorrected).

### Click Functionalization of Block-Polymer Grafted Silica Nanoparticles

A mixture of block copolymer grafted silica nanoparticles (1 equiv of —N₃), alkyne-terminated oligoaniline (2 equiv), and N,N,N′,N″,N″-pentamethyldiethylenetriamine (PMDETA) (0.5 equiv) was dissolved in THF. The solution was degassed by bubbling nitrogen for 5 minutes and transferred to a flask containing CuBr (0.5 equiv) under a nitrogen atmosphere. After reaction, the mixture was diluted with THF, and passed through neutral alumina to remove the copper catalyst. After concentration by rotary evaporation, the solution was precipitated into methanol to remove residual alkyne. After filtration, the product was dried under vacuum.

### Example 3

### Preparation of Polymer-Coated Silica Nanoparticles

In this example, reversible addition-fragmentation chain transfer (RAFT) polymerization was used to graft polymers on SiO₂ nanoparticles (ORGANOSILICASOL™ colloidal silica in Methyl isobutyl ketone (MIBK) from Nissan Chemical). 4-Cyanopentanoic acid dithiobenzoate (CPDB) served as the RAFT reaction agent.

The nanoparticles were modified using a living free radical polymerization method to create a rubbery inner block (molecular weight 10 Kg/mole) and an outer block with epoxy compatible groups (molecular weight 65 Kg/mole), and a graft density of 0.2 chains/nm². An example chemistry is shown in the schematic below:

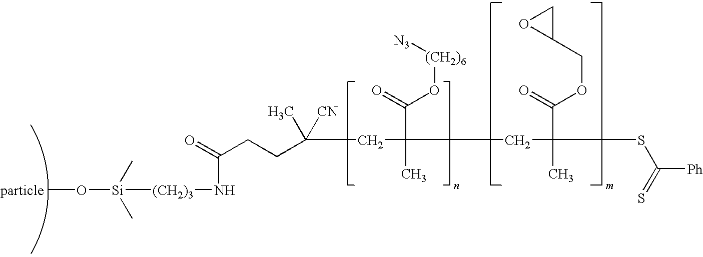

### Synthesis of 4-Cyanopentanoic Acid Dithiobenzoate (CPDB)

Twenty milliliters (ml) of phenyl magnesium bromide (3 M solution in ethyl ether) was added to a 250-mL, round-bottom flask, the phenyl magnesium bromide which was diluted to 100 mL with anhydrous tetrahydrofuran (THF). Carbon disulfide (4.6 g) was added dropwise, and the reaction was stirred for 2 hours at room temperature. The mixture was diluted with 100 ml of diethyl ether and poured into 200 ml of ice-cold hydrochloric acid (1 M). The organic layer was separated and extracted with 250 ml of cold sodium hydroxide solution (1 M) to yield an aqueous solution of sodium dithiobenzoate. The sodium dithiobenzoate solution was transferred to a 1000 mL round bottom flask equipped with a magnetic stir bar. An excess of aqueous potassium ferricyanide solution (300 mL) was added dropwise to the sodium dithiobenzoate via an addition funnel over a period of 1 hour under vigorous stirring. The reddish-pink precipitate formed was collected by filtration and washed with distilled water until the filtrate became colorless. The solid was dried under vacuum at room temperature overnight. Yield of di(thiobenzoyl)disulfide was 5.5 g (60%). Ethyl acetate (100 ml), 4,4′-azobis(4-cyanopentanoic acid) (7 g, 25 mmol), and di(thiobenzoyl)disulfide (5.5 g, 18 mmol), were added to a 250 mL round-bottomed flask. The reaction solution was heated at reflux for 18 hours. After removal of solvent and silica gel column chromatography (3:2 mixture of hexane and ethyl acetate), the product was obtained as a red solid (yield: 7.5 g, 75%). mp: 78° C. (capillary uncorrected).

### Synthesis of Activated CPDB

CPDB (1.40 g), mercaptothioazoline (0.596 g) and dicyclohexylcarbodiimide (DCC) (1.24 g) were dissolved in 20 ml dichloromethane. Dimethylaminopyridine (DMAP) (61 mg) was added slowly to the solution which was stirred at room temperature for 6-8 hours. The solution was filtered to remove the salt. After removal of solvent and silica gel column chromatography (5:4 mixture of hexane and ethyl acetate), activated CPDB was obtained as a red oil (1.57 g, 83% yield).

### Synthesis of CPDB Anchored Silica Nanoparticles

A solution (5 g) of colloidal silica particles (30 wt % in MIBK) and was added to a two necked round-bottom flask and diluted with 50 ml of THF. To this was added 3-aminopropyldimethylethoxysilane (0.25 ml), and the mixture was refluxed at 75° C. for 12-14 hours under nitrogen protection. The reaction was then cooled to room temperature and precipitated in large amount of hexanes. The particles were then recovered by centrifugation at 3000 rpm for 8 minutes and then dispersed in THF using sonication and precipitated in hexanes again. The amino functionalized particles were then dispersed in 40 ml of THF for further reaction.

A THF solution of the amino functionalized silica nanoparticles (40 ml, 1.6 g) was added dropwise to a THF solution (30 ml) of activated CPDB (0.5 g) at room temperature. After complete addition, the solution was stirred overnight. The reaction mixture was precipitated into a large amount of 4:1 mixture of cyclohexane and ethyl ether (2500 ml). The particles were recovered by centrifugation at 3000 rpm for 8 minutes. The particles were redispersed in 30 ml THF and precipitated in 4:1 mixture of cyclohexane and ethyl ether. This dissolution-precipitation procedure was repeated 2 more times until the supernatant layer after centrifugation was colorless. The red CPDB anchored silica nanoparticles were dried at room temperature and analyzed using Ultra Violet analysis to determine the chain density.

Graft Polymerization of Block Copolymer Brush from CPDB Anchored Colloidal Silica Nanoparticles.

A solution of hexyl methacrylate (40 mL), CPDB anchored silica nanoparticles (350 mg, 171.8 μmol/g), azobisisobutyronitrile (AIBN) (1 mg), and THF (40 mL) was prepared in a dried Schlenk tube. The mixture was degassed by three freeze-pump-thaw cycles, back filled with nitrogen, and then placed in an oil bath at 60° C. After 3.5 hours, 12 ml of glycidyl methacrylate was added to the Schlenk tube and the reaction was allowed to proceed for an additional 5 hours. The polymerization solution was quenched in ice water and poured into cold methanol to precipitate the polymer grafted silica nanoparticles. The polymer chains were cleaved by treating a small amount of nanoparticles with hydrofluoric acid. The molecular weight of the first homopolymer block was either 10 kg/mol or 30 kg/mol, depending upon experimental group, and the molecular weight of the outer block containing a mixture of hexyl methacrylate and glycidyl methacrylate was 30 kg/mol, 37 kg/mol, or 65 kg/mol as analyzed by Gel Permeation Chromatography. The chemistry and graft density of the tested polymer-SiO₂ nanoparticle composites is summarized in Table 1.

TABLE 1
Chemistry and Graft Density of Nanoparticle Composites

| | Molecular weight ratio of rubbery | Graft density |
|---|---|---|
| Particle ID | block/epoxy compatible block | (chains/nm²) |
| 10k + 47k-SiO₂ | 10 kg/mol:37 kg/mol | 0.21 |
| 30k + 60k-SiO₂ | 30 kg/mol:30 kg/mol | 0.21 |
| 30k + 95k-SiO₂ | 30 kg/mol:65 kg/mol | 0.71 |

### Preparation of Polymer-Coated Silica Nanoparticles Filled Epoxy Nanocomposite

The Huntsman Araldite® epoxy system was used as the thermosetting matrix polymer. The system includes (i) Araldite F—bisphenol A liquid epoxy resin; (ii) HY905—acid anhydride hardener (with diamine groups) and (iii) DY062—amine catalyst.

The nanoparticles prepared above were placed in a CH₂Cl₂ solvent (the concentration of the particle cores in CH₂Cl₂ was approximately 1 mg/ml); Epoxy resin was added to the solution to make a master batch (MB) containing 1% by weight of modified nanoparticles. The MB was mixed with an equal weight of alumina balls (⅛″ in D) in a Hauschid speed mixer according to the following sequence of mixing speeds and times: 20 seconds at 500 rpm, 20 seconds at 1000 rpm, 30 seconds at 2000 rpm and 60 seconds at 3500 rpm. After one sequence of mixing, the MB was mixed for 3 one minute intervals at 3500 rpm to cool the MB in ice. The calculated amount of epoxy resin for a targeted loading of particles in the nanocomposite was added to the MB and mixed in the Hauschid speed mixer for one sequence of mixing. The solvent in the mixture was evaporated in a fume hood overnight; HY905 hardener and DY062 catalyst were added to the mixture to make a sample batch (SB). The SB was cured in a dog bone sample silicone mold at 80 degrees C. for 10 hours and 135 degrees C. for 10 hours.

The calculation of the amount of epoxy resin to put in the MB to make an x wt % of particle cores in the polymer-coated SiO₂ nanoparticles filled epoxy nanocomposite is shown below:

W_{particle cores}/W_{EP}=x %/(1−(1+p)x %)

where, W_{particle cores} and W_{EP} denote for the weight of the SiO₂ nanoparticle cores and epoxy matrix, respectively, and p is the weight ratio of the grafted polymer to the particle cores for the grafted SiO₂.

The SiO₂ nanoparticles had an averaged diameter (D) of 15 nm. The average surface area (A) of the SiO₂ nanoparticles was 706.9 nm².

### Tensile Testing of Polymer-Coated Silica Nanoparticle-Filled Epoxy Nanocomposites

The following polymer-SiO₂/epoxy nanocomposites were tested for improved strain-to-break properties: a 2% by weight 10 k+47 k-SiO₂/epoxy nanocomposite, a 2% by weight 30 k+60 k-SiO₂/epoxy nanocomposite, a 0.1% by weight 30 k+95 k-SiO₂/epoxy nanocomposite. Neat epoxy (having no filler) was used as a control group.

The tensile test was conducted using an Instron 4201. Dog bone specimens of the neat epoxy and polymer-SiO₂/epoxy nanocomposites with thickness and width of 3 mm by 3 mm at the gauge section were used for the tensile test. The specimen was loaded at a strain rate of 0.1 mm/min until the failure happened. Data from the tensile test is summarized in Table 2.

TABLE 2
Mechanical Properties of Different Epoxy Systems.

| | Ultimate | | | |
|---|---|---|---|---|
| | Tensile | | | |
| | Stress | Strain to break | Increased Strain | Modulus |
| Sample | (MPa) | (%) | to break by | (GPa) |
| Neat epoxy | 83.7 ± 0.4 | 7.36 ± 1.15 | — | 3.3 ± 0.1 |
| 2 wt % 10k + 47k-SiO₂/epoxy | 79.7 ± 0.6 | 9.06 ± 1.04 | 23% | 3.2 ± 0.1 |
| 2 wt % 30k + 60k-SiO₂/epoxy | 79.1 ± 0.1 | 9.18 ± 2.02 | 25% | 3.3 ± 0.1 |
| 0.1 wt % 30k + 95k-SiO₂/epoxy | 82.0 ± 0.1 | 14.2 ± 2.44 | 93% | 3.3 ± 0.2 |

MPa = Megapascal
GPa = Gigapascal

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A modified nanoparticle comprising
a nanoparticle; and
a diblock copolymer covalently attached to the nanoparticle;
said diblock copolymer comprising a first block polymer of molecular weight greater than 1000 attached to the nanoparticle and a second block polymer of molecular weight greater than 1000 covalently linked to the first block polymer, wherein at least one of said first block polymer and said second block polymer comprises repeating units having an azide, acetylene or triazole side chain.

2. The modified nanoparticle of claim 1, wherein said first block polymer comprises repeating units having a triazole in the side chain.

3. The modified nanoparticle of claim 2, wherein said triazole is of the formula 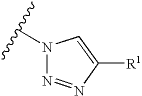
wherein R1 is chosen from a polyaniline, a polyolefin, and the wavy line indicates the point of attachment to the side chain.

4. The modified nanoparticle of claim 1, wherein said second block polymer comprises repeating units having a triazole in the side chain.

5. The modified nanoparticle of claim 4, wherein said triazole is of the formula 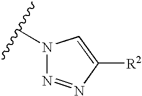
wherein R² is chosen from a glycidyl ether, an ester, an aliphatic hydrocarbon, an aromatic hydrocarbon, a phenol, an amide, an isocyanate and a nitrile and the wavy line indicates the point of attachment to the side chain.

6. The modified nanoparticle of claim 1 wherein the nanoparticle has a diameter of 1-100 nanometers.

7. The modified nanoparticle of claim 1, wherein the molecular weight of the first block copolymer is from 1 Kg/mole to 200,000 Kg/mole.

8. The modified nanoparticle of claim 1, wherein the molecular weight of the second block copolymer is from 1 Kg/mole to 200,000 Kg/mole.

9. The modified nanoparticle of claim 1, wherein the diblock copolymer contains a first block polymer with a glass transition temperature lower than the second block polymer.

10. A nanoparticle filled polymer composite comprising
a modified nanoparticle; and
a polymeric matrix,
wherein said modified nanoparticle comprises a nanoparticle; and a diblock copolymer covalently attached to the nanoparticle;
said diblock copolymer comprising a first block polymer of molecular weight greater than 1000 attached to the nanoparticle and a second block polymer of molecular weight greater than 1000 covalently linked to the first block polymer, wherein said second block polymer and said polymeric matrix both possess the same chemical functionality.

11. A nanoparticle filled polymer composite according to claim 10 wherein the second block polymer and the polymeric matrix both possess functionality chosen from:
(a) epoxide/ether;
(b) ester;
(c) aliphatic hydrocarbon;
(d) aromatic hydrocarbon;
(e) phenol/resole;
(f) amide;
(g) isocyanate/urethane; and
(e) nitrile.

12. A nanoparticle filled polymer composite according to claim 10 wherein the first block polymer comprises repeating units having a triazole in the side chain.

13. The nanoparticle filled composite according to claim 12, wherein said triazole is of the formula 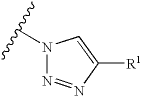
wherein R1 is chosen from polyaniline, a polyolefin, and the wavy line indicates the point of attachment to the side chain.

14. A nanoparticle filled polymer composite according to claim 10 wherein at least one of said first block polymer and said second block polymer comprises repeating units having a triazole side chain.

15. A method for preparing a nanoparticle filled polymer composite comprising:
(a) providing a modified nanoparticle;
(b) immersing said nanoparticle in a prepolymer resin; and
(c) polymerizing said resin;
wherein said modified nanoparticle is modified such that a block copolymer is attached to the nanoparticle, said block copolymer having an inner polymer proximal to the nanoparticle and a matrix compatible outer polymer distal to the nanoparticle.

16. A method for preparing a nanoparticle filled polymer composite comprising:
(a) providing a modified nanoparticle;
(b) melting or dissolving a polymer matrix;
(c) immersing said modified nanoparticle in said polymer matrix;
(d) allowing the nanoparticle filled polymer matrix to harden
wherein said modified nanoparticle is modified such that a diblock copolymer is attached to the nanoparticle, said diblock copolymer having an first block polymer proximal to the nanoparticle and a matrix compatible second block polymer distal to the nanoparticle.

17. A method for preparing a nanoparticle filled polymer composite comprising:
(a) covalently attaching to a nanoparticle, by RAFT polymerization, a diblock copolymer, said diblock copolymer comprising a first block polymer attached to the nanoparticle and a second block polymer covalently linked to the first block polymer, wherein at least one of said first block polymer and said second block polymer comprises repeating units having a side chain that supports a dipolar cycloaddition;
(b) carrying out a dipolar cycloaddition such that a product of said cycloaddition is preferentially attached to side chains of one or the other of said first block polymer and said second block polymer;
(c) immersing said nanoparticle in a prepolymer resin; and
(d) polymerizing said resin.

18. A method for preparing a nanoparticle filled polymer composite comprising:
(a) covalently attaching to a nanoparticle, by RAFT polymerization, a diblock copolymer, said diblock copolymer comprising a first block polymer attached to the nanoparticle and a second block polymer covalently linked to the first block polymer, wherein at least one of said first block polymer and said second block polymer comprises repeating units having a side chain that supports a dipolar cycloaddition;
(b) carrying out a dipolar cycloaddition such that a product of said cycloaddition is preferentially attached to side chains of one or the other of said first block polymer and said second block polymer;
(c) melting or dissolving a polymer matrix;
(d) immersing said modified nanoparticle in said polymer matrix;
(e) allowing the nanoparticle filled polymer matrix to harden.

19. A method according to claim 17 for preparing a nanoparticle filled polymer composite comprising:
(a) covalently attaching to a nanoparticle, by RAFT polymerization, a diblock copolymer, said diblock copolymer comprising a first block polymer attached to the nanoparticle and a second block polymer covalently linked to the first block polymer, wherein at least one of said first block polymer and said second block polymer comprises repeating units having an azide or acetylene side chain;
(b) reacting an acetylene with said azide or an azide with said acetylene to attach a triazole to a side chain such that said triazole is preferentially attached to side chains of one of said first block polymer and said second block polymer;
(c) immersing said nanoparticle in a prepolymer resin; and
(d) polymerizing said resin.

20. A method according to claim 15 wherein said nanoparticle has been modified by attaching a diblock copolymer attached to the nanoparticle wherein the inner block polymer provides a layer that possesses a mechanical, electrical or optical property different from the prepolymer resin and the outer block polymer provides a layer that possesses a mechanical or chemical property compatible with the prepolymer resin.

21. A method according to claim 20 wherein the mechanical, electrical or optical property of the inner layer or the mechanical or chemical property of the outer layer is imparted by attaching side chains via a click reaction.

22. A method according to claim 21 wherein the mechanical, electrical or optical property of the inner layer is chosen from resiliency, electrical conductivity, electrical insulation, optical absorption, optical reflection and optical radiation.
